(19) United States
(12) Patent Application Publication
(10) Pub. No.: US 2004/0267590 A1
(43) Pub. Date: Dec. 30, 2004

(54) Dynamic software licensing and purchase architecture

(75) Inventors: David Kingsley Clark, Cedar Park, TX (US); Julie Louise Gilbreath, Liberty Hill, TX (US); Theodore Jack London Shrader, Austin, TX (US); Steven F. Southworth, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/610,785

(22) Filed: Jun. 30, 2003

(51) Int. Cl. G06F 17/60

(52) U.S. Cl. 705/9; 705/1

(57) ABSTRACT

A method, computer program product, and data processing system for supporting application-generic licensing and purchasing of software in an intranet or internet in disclosed. A client license application resides on a client computer. The client license application cooperates with a software delivery server to install new software. The software delivery server uses a resource discovery protocol to identify software applications meeting requirements of the client license application. The software delivery server initiates the purchase of licenses at a purchase server and the installation of the software on the client computer.

A license database is used to keep track of software licensed for use by particular users, organizations, or data processing systems. The software delivery server provides the additional feature of periodically consulting the license database to determine whether to notify a user of an expired or soon-to-expire software license or new versions of software that may replace currently installed versions.

### BACKGROUND OF THE INVENTION

1. Technical Field

The present invention relates generally to automated systems for licensing software applications in an organization such as a business enterprise. More specifically, the present invention relates to a flexible and scalable architecture for handling software licensing and purchase transactions.

2. Description of Related Art

Site licensing is an important marketing strategy for commercially-produced software. Since selling individual physical copies of software is neither cost-effective nor an effective means of preventing software piracy (since it is so easy to make duplicate copies), site licensing has become increasingly prevalent in recent years. Rather than selling individual physical copies, software vendors sell licenses to allow a certain number of users or a certain number of machines (e.g., workstations) in an organization to use a particular program.

A site license for a software application may be enforced through the use of software specifically designed for that purpose. For example, some applications that are designed to be licensed for use on multiple machines in a single organization include license-enforcing code to only permit a certain number of active users of the application at one time. With such applications, it is possible for a software vendor to site-license an application to an organization so that the terms of the license are enforced and so that the maximum number of users can take advantage of the license. For example, if there is a site license for 8 active users of an application, more than 8 users can actually make use of the application, as long as only 8 users are using the application concurrently. This kind of licensing arrangement is particularly suited to the university lab setting, in which only a fraction of the students allowed to use a particular application will be using the application at any one time.

These forms of license enforcement, however, suffer from a number of drawbacks. Most of these schemes are application-specific; that is, the application itself must support the licensing scheme. In addition, little concern is given to the scalability of such software or to the ability to employ such software over wide-area networks.

Thus, a need exists for a software licensing and purchase system that is application-generic and that is scalable in terms of computing loads and geographic distribution.

### SUMMARY OF THE INVENTION

The present invention is directed to a method, computer program product, and data processing system for supporting application-generic licensing and purchasing of software in an intranet or internet. A client license application resides on a client computer. The client license application cooperates with a software delivery server to install new software. The software delivery server uses a resource discovery protocol to identify software meeting characteristics specified by the client license application. The software delivery server initiates the purchase of licenses at a purchase server and initiates the installation of the software on the client computer.

A network-accessible license database is used to keep track of software licensed for use by particular users, organizations, or data processing systems. The software delivery server provides the additional feature of periodically consulting the license database to determine whether to notify a user of an expired or soon-to-expire software license or of new versions of software that may replace currently installed versions.

In a preferred embodiment, the entire architecture is based on Web services and Web services protocols, such as Simple Object Access Protocol (SOAP). This allows for the architecture to be distributed over a large geographic area or across organizations; in such situations individual components may be realized using markedly heterogeneous technologies.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed data processing system in which a preferred embodiment of the present invention may be implemented;

FIG. 2 is a block diagram of a data processing system exemplifying a server in which a preferred embodiment of the present invention may be implemented;

FIG. 3 is a block diagram of a data processing system exemplifying a client in which a preferred embodiment of the present invention may be implemented;

FIG. 4 is a component diagram depicting an exemplary architecture for implementing a preferred embodiment of the present invention;

FIG. 5 is a class diagram depicting relationships between data entities in a preferred embodiment of the present invention;

FIG. 6 is an activity diagram depicting a process of requesting and installing a software application in accordance with a preferred embodiment of the present invention;

FIG. 7 is an activity diagram depicting a process of enforcing software licenses in a preferred embodiment of the present invention; and

FIG. 8 is an activity diagram depicting a process of locating and installing software updates in a preferred embodiment of the present invention.

### DETAILED DESCRIPTION OF THE PREFERRED EMBODIMENT

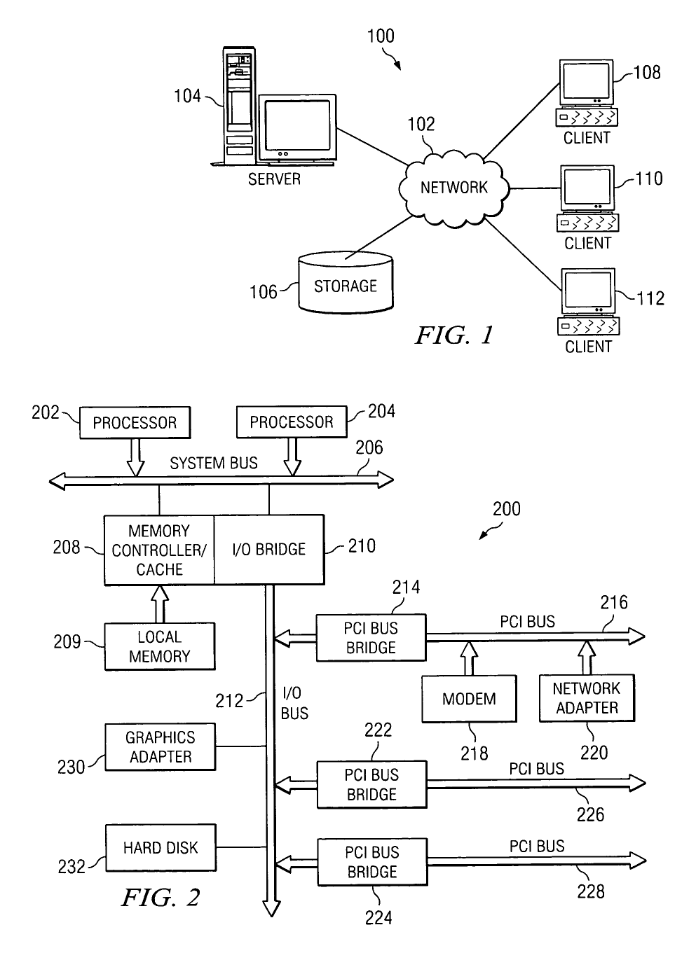

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system.

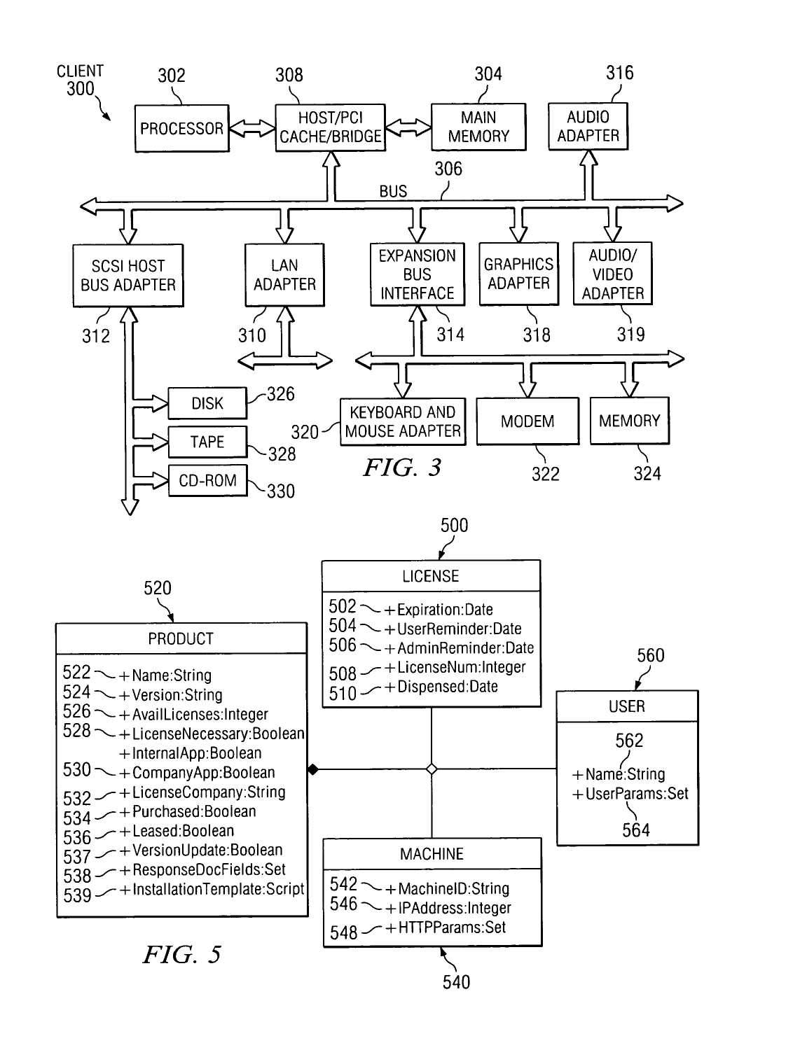

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention is directed to a method, computer program product, and data processing system for supporting application-generic licensing and purchasing of software in an intranet or internet. A preferred embodiment of the present invention utilizes Web services to realize these features. Before delving into the details of this preferred embodiment, it is thus important to understand what is meant by a Web service.

Unfortunately, although “Web service” is a term of art and has a more specific meaning than its literal language, the concept of a Web service is an evolving one, and a standardized terminology in this area has not yet been achieved. The closest thing to an official definition of the term “Web service” is provided in a working draft of the World-Wide Web Consortium (W3C) entitled “Web Services Glossary.” The W3C is the standards body responsible for promulgating World-Wide Web-related computing standards. In particular, the W3C has a working group devoted to developing an architecture of related protocols for supporting Web services, called the Web Services Architecture (q.v.). According to the current working draft of the aforementioned “Glossary,” a Web service is:

A software system identified by a URI (Uniform Resource Identifier), whose public interfaces and bindings are defined and described using XML (eXtensible Markup Language). Its definition can be discovered by other software systems. These systems may then interact with the Web service in a manner prescribed by its definition, using XML based messages conveyed by Internet protocols.

The URI standard for identifying World-Wide Web (WWW) resources and the XML standard for platform-independent formatting of structured data are both W3C standards in common usage today. The above W3C describes the vast majority of software systems in common usage today that fall under the term “Web service,” since the protocols of W3C's Web Services Architecture are the de facto standard for supporting Web services (despite the fact that the Web Services Architecture is still an evolving set of standards).

For the purposes of this document, however, the above definition is considered too limiting. As computing standards (particularly network-related standards) evolve over time, it is recognized that a definition of Web service that is specific to particular protocols, while it may have illustrative value, does not adequately capture those aspects of Web services that are protocol-independent. The following definition, taken from the IBM Redbook entitled “WebSphere Version 5 Web Services Handbook,” is a more generic, yet equally correct, definition of the term “Web service”:

Web services are self-contained, modular applications that can be described, published, located, and invoked over a network.

One of ordinary skill in the art will recognize that this definition encompasses the W3C definition of a Web service, but is broader in the sense that W3C-standard protocols need not be used. While this definition is clearly more generic than the W3C definition, it is felt that this definition does not do an adequate job of accentuating the distinguishing features of Web services from other web-based application technologies.

Thus, the following definition of Web service is adopted herein: A Web service is an application that can be published and located in a network and that can be invoked via an interface that can be described in a form that is discoverable and/or readable by another software component over the network.

One of ordinary skill in the art will recognize that the definition given above encompasses the W3C definition of a Web service, but does not limit the Web service concept to any particular protocols or languages. At this point, however, it is important to understand what are Web services protocols in view of the definition of Web service adopted above. To this end, it is helpful to consider existing Web services protocols and languages within the W3C Web Services Architecture.

The W3C Web Services Architecture is based primarily on extensible Markup Language, or XML as it is more commonly referred to. XML, which is defined as a W3C standard, is a character-based markup language that is designed for annotating data with semantic information that can be parsed by a computer. XML is used to provide a standardized syntax for information exchange between software processes.

XML by itself has a very minimal semantics, as XML merely provides a standardized syntax for imposing a hierarchical structure on data. XML, like HTML (Hypertext Markup Language) and other similar markup languages, uses tags to encode structural information about the data. HTML, for example, uses tags to encode structural (e.g., headings, section breaks, etc.) and formatting information about a hypertext document. XML, on the other hand, is more general than HTML. While HTML defines tags that have a particular semantics related to document structuring, XML does not define particular tags, but provides only a syntax for creating user-defined tags. It is up to a user (e.g., a programmer, database administrator, etc.) to define semantic tags in XML. What minimal semantics is provided by XML itself is essentially limited to the ability of XML tags to form information hierarchies through the nesting of tags and the ability to associate data attributes with individual tags.

What this essentially means is that XML can be used to create markup languages that can be parsed using off-the-shelf parsing code. This allows developers to create custom languages for data exchange without the hassle of having to write a parser for the language. For instance, one can create a custom markup language for encoding musical scores by using XML tags. It would not be necessary to write a parser for the language, since a generic XML parser would immediately be able to parse the language. In short, XML provides a standardized, platform-independent format for data exchange, which decouples the language syntax from the language semantics such that a standardized syntax can be used to encode structured data having an arbitrary choice of semantics.

The other W3C Web service protocols and languages are based on XML. W3C-type Web services use XML-derived markup languages for all aspects of data exchange. XML Schemas (also a W3C standard) are used to encode meta-data that describe the particular XML-derived markup language being used. For example, an XML Schema could be created to define the legal data types and legal structural hierarchies in the aforementioned musical markup language. Essentially, XML Schemas define the ground rules for a given XML-derived markup language and impose correctness constraints on derived language. W3C Web services protocols and languages are defined in terms of XML Schemas, and data exchanged in these protocols and languages are encoded in the form of XML documents in accordance with the particular XML Schema for the Web service protocol or language being used.

The primary Web services protocols and languages in the W3C Web Services Architecture are generally known by their acronyms, SOAP, UDDI, and WSDL. Each of these protocols and languages is defined by a standard specification. SOAP and WSDL are defined by W3C standard documents, while UDDI is defined by a standard promulgated by OASIS (Organization for the Advancement of Structured Information Standards), a non-profit industry consortium devoted to the establishment of standards for electronic business.

SOAP (Simple Object Access Protocol) is a protocol for invoking a Web service over a network. SOAP provides an ability to serialize a Web service invocation request or response and any associated data into a standardized XML-based form for use in invoking a Web service. A (hardware) server hosting a Web service can employ a SOAP (software) server for receiving invocation requests in SOAP and de-serializing those requests into a form suitable for execution by the Web service application program itself. Since SOAP serializes information into a standard format, SOAP makes it possible to invoke Web service code in a platform- and language-independent way. For example, a client program that wishes to make use of a Web service need not know anything about the language or platform of the server hosting the Web service, since the server can take case of de-serializing SOAP requests into a suitable format for the Web service application. Similarly, the Web service's response to the request will also be serialized in the form of a SOAP message.

SOAP provides serialization and other features related to platform-independent remote invocation of Web services, such as data security features. SOAP is not intended to be used as a transport protocol, however. SOAP messages are generally encapsulated within some form of application-level transport protocol, typically HTTP (Hypertext Transfer Protocol), which is the primary transport protocol for the World-Wide Web.

UDDI (Universal Description, Discovery, and Integration) is a form of distributed database for storing and retrieving information about Web services. UDDI is similar in design to DNS (Domain Name Service), which is the distributed database used to map character-based domain names (e.g., “www.ibm.com”) into numerical network addresses for use in routing packets over the Internet. UDDI might also be analogized to a telephone book. Whereas DNS is like the “white pages” (mapping a name to an address), however, UDDI is a bit more like the “yellow pages,” mapping service attributes into service locations and descriptions.

A UDDI registry contains information about Web services. Since UDDI is a distributed database standard, a registry may span a number of different UDDI servers, and, much like DNS, each server is capable of consulting other servers to locate desired Web services. An entry in a UDDI registry will provide information about a particular Web service, including its location (e.g., a URI), information about how to use the service (e.g., as an XML Schema or as a WSDL document, about which more will be said shortly), and other attributes that may be useful in identifying a desired service. A client wishing to locate a Web service to meet particular needs can consult the UDDI registry to locate entries for Web services that meet those needs. A consortium of companies, including IBM, Microsoft, and other major vendors, have established a public UDDI registry that may be used, much like DNS, as a master directory to locate listed Web services. Typically, a UDDI registry will itself be implemented using Web services, so that SOAP or some other comparable protocol can be used for storing or retrieving UDDI registry information.

UDDI is designed to store information about Web services according to classification schemes. A familiar form of classification scheme is the Dewey decimal system commonly used in libraries. UDDI does not require the use of any particular classification scheme, and a UDDI entry may include any number of classifications for the purpose of assisting searches. Thus, UDDI provides a convenient way of organizing and indexing information by category or type.

The Web service-related information stored by UDDI registries need not be encoded in any particular language. WSDL (Web Service Description Language), an XML-derived markup language, is specifically designed for encoding descriptive information about Web services. WSDL is defined as a W3C standard.

In view of the above description of existing W3C Web services protocols and languages, the following definition of the term “Web services protocol” is adopted in this document: A Web services protocol is a protocol or language that supports the discovery of Web services, the acquisition of information about Web services, or the invocation of Web services over a network.

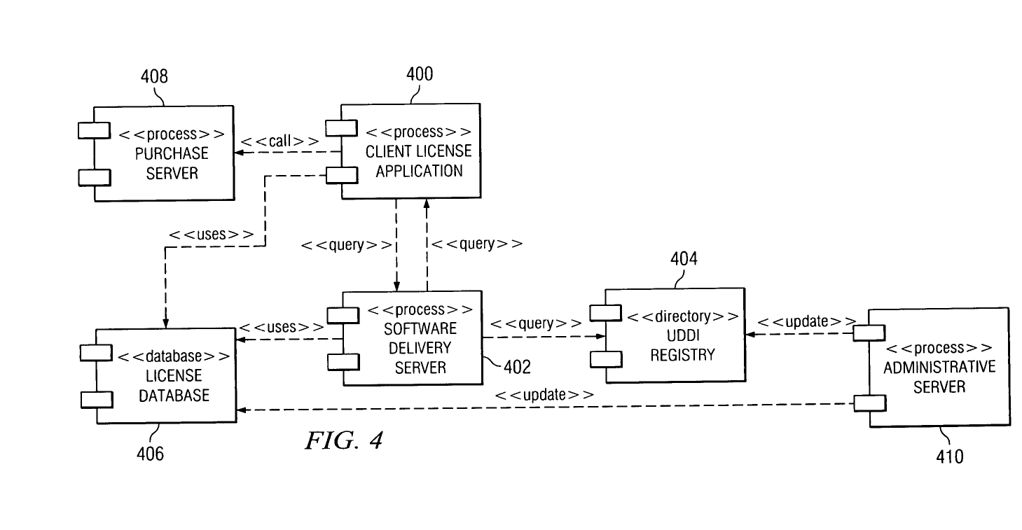

Returning attention now to a preferred embodiment of the present invention and with reference to FIG. 4, the components of a preferred embodiment of the present invention are described. In this preferred embodiment, each of the components depicted in FIG. 4 are implemented as Web services using the W3C Web Services Architecture. In particular, this preferred embodiment utilizes SOAP to allow the components to communicate with one another in a platform independent form.

Since this preferred embodiment utilizes Web services, the various components depicted in FIG. 4 may be deployed in numerous ways across different data processing systems in an internet, intranet, or local area network. One of ordinary skill in the art will also recognize that one or more of these components may be deployed on a common hardware platform. Software delivery server 402 and license database 406 may be deployed on the same server, for instance.

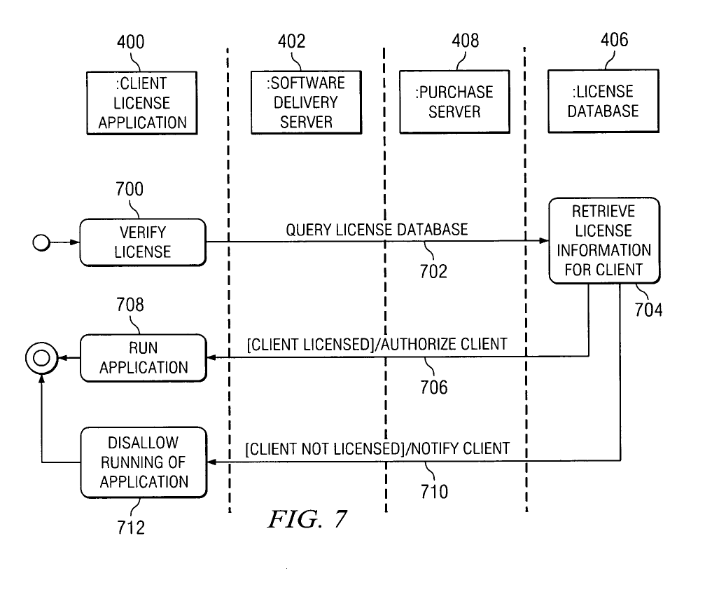

Client license application 400 is a software process associated with a client data processing system on which software applications are installed. That is to say that client license application 400 is preferably a stand-alone program that is separate from the programs installed and/or licensed under the direction of client license application 400. Client license application 400 is responsible for initiating requests for installation of applications with software delivery server 402, as well as ensuring that an application to be executed on the client is properly licensed as a prerequisite to execution by consulting license database 406 (as shown in FIG. 7). Client license application 400 also performs many of the actual tasks involved in downloading and installing software applications, under the direction of software delivery server 402. Client license application 400 may also handle the payment for installed software by invoking purchase server 408.

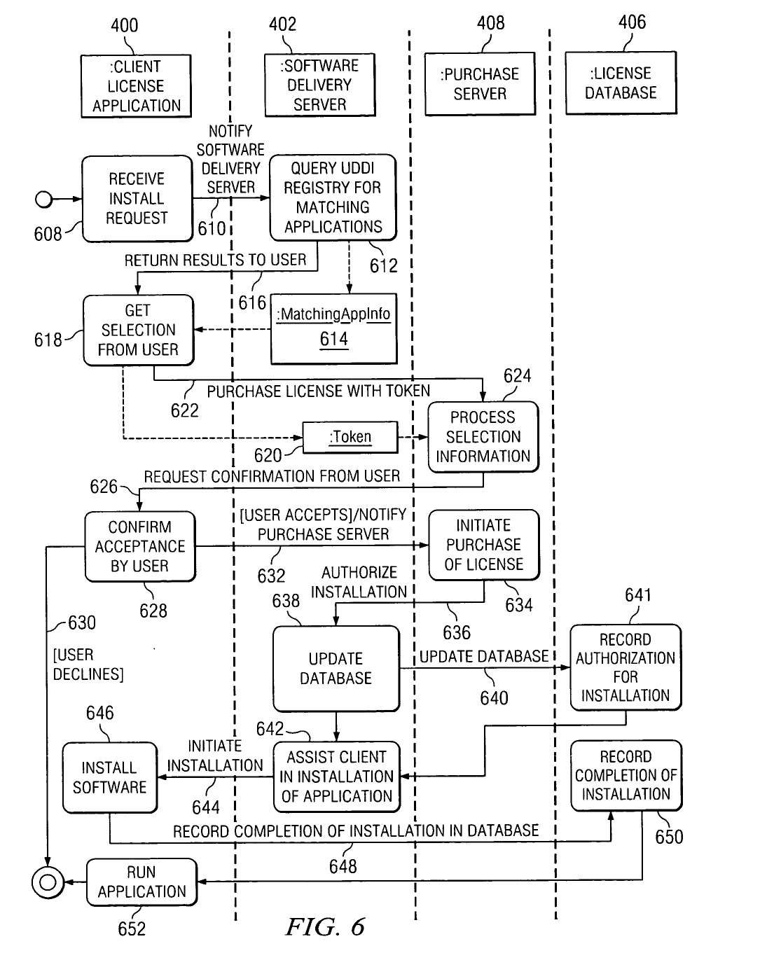

Software delivery server 402 may be considered the heart of the system. Software delivery server 402 receives requests from client license applications (there will likely be many of them in a given organization or in an internet). In response to these requests, software delivery server 402 locates software applications using UDDI registry 404 and directs the licensing and installation of those applications by interacting with license database 406 and client license application 400. This process is described in more detail in FIG. 6.

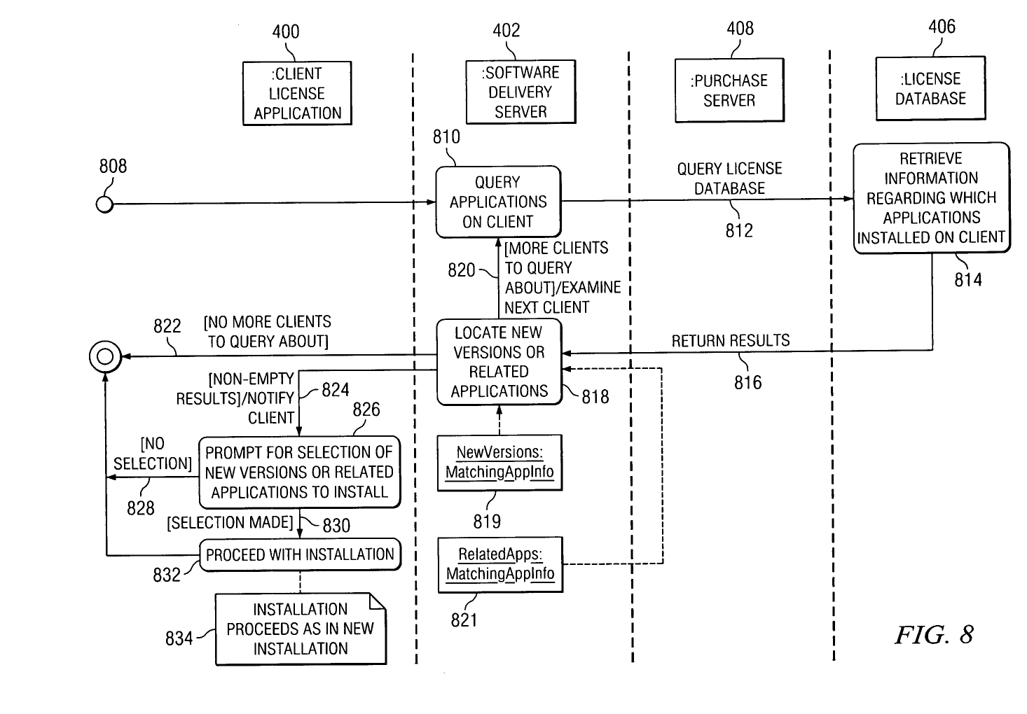

In addition, software delivery server 402 proactively monitors license database 406 to determine if any applications installed on a client will need a replacement, upgrade, or license renewal. If any applications have become obsolete or unsupported, or if an application's license will soon expire (or has already expired), software delivery server 402 can notify client license application 400 of the situation so that, with user approval, software delivery server 402 can upgrade or replace the application or renew the application's license, as appropriate. This process is described in more detail in FIG. 8.

UDDI registry 404 stores information regarding software applications that may be installed on clients. Since the UDDI standard supports organizing information according to category, UDDI registry 404 can be searched by category to retrieve entries that provide descriptive information (name, summary description, download location, price, vendor, license terms, etc.) about available software applications in a desired category (e.g., word processors, accounting software, etc.). Information retrieved from UDDI registry 404 is used by software delivery server 402 to identify candidate software applications for installation, as well as to inform software delivery server 402 as to how an application is licensed, downloaded, and installed onto a client.

License database 406 stores information regarding which applications are licensed for use with which clients and under what terms. License database 406 is consulted by client license application 400 to validate a license of a particular application before executing the application. License database 406 is consulted by software delivery server 402 to determine if a client has software that should be upgraded or a license that will soon expire. In addition, software delivery server 402 updates license database 406 to indicate when an application has been newly licensed for use on a client. Since license database 406 is the primary information storage facility in a preferred embodiment of the present invention, a class diagram depicting an exemplary set of data objects and relationships for license database 406 is depicted in FIG. 5.

Purchase server 408, in a preferred embodiment, handles the monetary purchase of a software license. In the event that purchase server 408 is associated with a software vendor on an internet, this monetary purchase may take place by way of bank draft, credit card, or other form of electronic payment system. In an alternative embodiment, purchase server 408 may not deal in actual money at all, but may use data tokens, counters, or some other form usage limitation scheme. For example, in an embodiment in which purchase server 408 resides in a corporate intranet, purchase server 408 may simply count the number of active licenses for a particular application and disallow installation of additional copies of the application if the number of active licenses exceeds some maximum number allowed. In this way, an organization can purchase a particular number of software licenses from a vendor and use an internal purchase server to limit the actual usage of the application to the number of licenses purchased.

An administrative server 410 administers the two databases, UDDI registry 404 and license database 406. Administrative server 410 is used primarily to create and update entries in UDDI registry 404 to reflect changes in the availability of software and to update license database by creating database entries for new users, clients, applications, and the like. Administrative server 410 can be used to make manual modifications to the information stored in these databases.

FIG. 5 is a class diagram depicting data objects and relationships in license database 406 in accordance with a preferred embodiment. In a preferred embodiment, license database 406 is supported by some form of relational or object-relational database (such as DB2, an IBM product), although the actual form or type of database management system used is not essential to the present invention. Although FIG. 5 is a class diagram, which implies the use of an object-oriented or object-relational database management system, one of ordinary skill in the art will recognize that a database that does not support such object-oriented features as objects and classes can also be used to realize an embodiment of the present invention without departing from the scope or spirit of the present invention. The translation of class diagrams (or entity-relationship diagrams) into database schemas is well-known in the art and is not described here.

FIG. 5 shows that, in general, a license (license class 500) relates a software application product (product class 520) with a client machine (machine class 540) and a user (user class 560). This follows from the fact that a license allows a user to utilize a software application product on a client machine. Since all users in a given organization might be licensed to use a product or a user in a given organization may be licensed to use a product on any machine in the organization, a license that is recorded in license database 406 may not be associated with a particular user or with a particular machine. In additional, a particular license might be associated with several machines or several users. It should also be kept in mind that FIG. 5 is merely intended to represent an example of the types of information that can be stored in license database 406 and the way in which such information may be organized.

License class 500 has a number of attributes that are illustrative of the types of information that can be associated with a single license in license database 406. An expiration date (attribute 502) is provided, as well as dates at which a user (attribute 504) or a system or network administrator (attribute 506) should be reminded that the license will expire soon. A license identification number (attribute 508) and a date that the license was dispensed (attribute 510) are also provided.

Product class 500 contains attributes that describe a single software application product. Attributes are provided for the name of the software application (attribute 522), the version of the application (attribute 524), a number of licenses that are currently available for use (e.g., in an organization that has purchased a limited number of shared licenses) (attribute 526), an indication that the application is an internal application (i.e., an application developed by an organization for that organization's internal use) (attribute 528), an indication that the application is a company application (i.e., an application developed by an organization for sale outside the company as well as within the company) (attribute 530), a name of a company from which the application is licensed (attribute 532), whether the license is purchased (attribute 534), whether the license is leased (attribute 536), whether an updated version is available (attribute 537), and a set of response document fields (attribute 538) which may include data fields for tracking when expiration notices are sent to users or when licenses are updated and may also include any additional data or comments entered by an administrator. Additionally, an installation template (attribute 539) is included to define a default set of actions to be taken to perform an unattended (i.e., automated) installation of the product on a client workstation. This installation template may be overridden as necessary, depending on the specific installation requirements. In a preferred embodiment, the installation template may alternatively be stored by client license application 400 or in UDDI registry 404 (see FIG. 4), or it may be stored in any combination of these components.

One of ordinary skill in the art will recognize that a similar data structure to product class 520 may be used for the entries stored in UDDI registry 404, since UDDI registry 404 also stores information regarding software applications. The UDDI registry entries will generally have some different attributes than product class 520. In particular, the UDDI registry entries will contain information regarding download locations and category information to allow software delivery server 402 to identify and initiate the downloading and installation of an application that meets user needs.

Machine class 540 represents a particular client machine (for example, a workstation in an organization). A string containing a machine ID or name (attribute 542), a numerical Internet Protocol or other network address (attribute 546), and a set of communications parameters (for example, HTTP parameters such as a port number or supported MIME types-MIME stands for Multipurpose Internet Mail Extensions, which are a standard way of describing document formats on the Internet).

User class 560 represents a particular user. Attributes for a user name (attribute 562) and a set of additional user parameters (attribute 564) is provided.

In view of FIG. 5, the roles played by the various components in FIG. 4 should become clearer. Software delivery server 402 primarily creates and monitors records of licenses, which associate a product with machine(s) and/or user(s). In addition to creating records of licenses in license database 406, software delivery server 402 monitors license database 406 to identify licenses that are soon to expire (via any of attributes 502-506) or that refer to products that should be updated or replaced (attribute 538). Client license application 400 consults license database 406 to identify whether a valid license exists for a given combination of a product (product class 520) and user (user class 560) and/or machine (machine class 540).

FIG. 6 is an activity diagram depicting a process of requesting and installing a software application in accordance with a preferred embodiment of the present invention. An activity diagram shows how individual software components operate internally, as well as in conjunction with one another.

Client license application 400 receives a user or administrator request to install a software application on a client data processing system (action state 608). In response, client license application 400 notifies software delivery server 402 of the request and of the characteristics of the software application to be installed (e.g., word processing program, compatible with Linux, support equation editing, etc.) (action 610). Software delivery server 402 then queries UDDI registry 404 (FIG. 4) to find a suitable application (or applications, if the user will have a choice) (action state 612). The results of querying UDDI registry 404 (denoted in the diagram as matching application information object 614) are then reported back the user or administrator that made the request (action 616).

At this point the user can, via client license application 400, select whether to install one of the choices of applications found by software delivery server 402 (action state 618). Client license application 400 then purchases a license for the application from purchase server 408 (action 622). In this example, client license application 400 uses a token 620, a data object that represents an ability to purchase a license. Recall that in an actual embodiment, actual payment information, such as a bank or credit card account number, may be used, or some other form of resource control may be employed instead. The user's purchase selection is validated by purchase server 408 (action state 624), and purchase server 408 requests a confirmation from the user at client license application 400 (action 626).

The user is then given an opportunity to confirm the purchase transaction (action state 628). If the user declines to participate in the transaction (action 630), the process terminates. If the user makes an acceptance, however, client license application 400 notifies purchase server 408 (action 632), and purchase server 408 initiates the license purchase process (action state 634). This may involve charging the purchase price of the license to a bank or credit account, for example, and depends on the form of payment. Since payment for goods and services over a network is widely known in the art, we will not elaborate any further on this point.

Purchase server 408, in response to the notification received from client license application 400, notifies software delivery server 402 that it is authorized to begin installing the application (action 636). Software delivery server 402 updates license database 406 to reflect the authorization (action state 638, action 640, action state 641). In the information schema depicted in FIG. 5, this could be done by creating a license record according to license class 500, for example.

Either in response to completing this database update operation or concurrently with that operation, software delivery server 402 assists client license application 400 in installing the application (action state 642, action 644, action state 646). This may occur in a variety of different forms. For example, software delivery server 402 might first download the application from a vendor or some other location on the network, package the application as a self-extracting executable installer program, then direct client license application 400 to download and execute the installer program. Alternatively, software delivery server 402 might simply provide an address (such as a Uniform Resource Identifier) from which to download the application for installation. Other variations in the manner in which software delivery server 402 initiates the installation of an application at client license application 400 (action 644) will be apparent to those skilled in the art and may be employed without departing from the scope and spirit of the present invention.

In response to installing the software, client license application 400 then accesses license database 406 to record that installation has completed (action 648). In the information schema depicted in FIG. 5, license database 406 may indicate completion of installation (action state 650) by setting an attribute in the record corresponding to the license in question. For example, expiration date attribute 502 might be set in response to the completion of installation to denote that the license expires at the end of a particular time period measured from the when the software is installed. Once license database 406 has been updated to indicate that the software is licensed and installed, client license application 400 may then execute the application.

FIG. 7 is an activity diagram depicting a process of enforcing a software license prior to execution of an application in a preferred embodiment of the present invention. Client license application 400, in response to the user's attempting to execute the application, begins a process of verifying that that the application is properly licensed (action state 700). Client license application 400 queries license database 406 (action 702) to determine whether a valid license for the application is still in effect.

License database 406 retrieves the necessary licensing information, as a record in license class 500 (FIG. 5), for example. If the client is licensed to execute the desired application, license database 406 notifies client license application 400 that the client is authorized to execute the desired application (action 706), and the client license application 400 initiates the execution of the application (action state 708). If there is no valid license (because one was never purchased or one that was purchased has expired), license database 406 notifies client license application 400 that execution of the application is not authorized. In response, client license application 400 disallows execution of the desired application (e.g., by terminating without initiating execution of the desired application or by deleting or otherwise enabling the installed copy of the desired application.

FIG. 8 is an activity diagram depicting a process of locating and installing software updates or replacements in a preferred embodiment of the present invention. Software delivery server 402 proactively queries license database 406 to determine which applications are installed on the client data processing system (action state 810, action 812). License database 406 returns the query results to software delivery server 402 (action state 814, action 816), which then determines if there are any new versions of the installed application or if there are any related applications that might supplement or replace those installed on the client by consulting UDDI registry 404 (FIG. 4).

UDDI entry information regarding the new versions (new versions object 819) and/or related applications (related applications object 821) are returned to software delivery server 402. If the results of querying UDDI registry 404 are non-empty (i.e., there are new versions or related applications that might be installed), software delivery server 402 notifies client license application 400 (action 824). Client license application 400 then prompts a user or administrator associated with client license application for a selection of new versions or related applications to install (action state 826). In one possible embodiment, this might be done by presenting a dialog box on the user's display at the next time the user logs into the client machine in question. Alternatively, this prompting may be accomplished by client license application 400's leaving a message in the user's electronic mail inbox with a hyperlink to a URL (Uniform Resource Locator) to allow the user to open a user interface to client license application 400 via a web browser. In response to the user's making a selection of an application or applications to be installed (action 830), client license application 400 then initiates a process of installation in accordance with FIG. 6 (action state 832, note 834).

Software delivery server 402, in this preferred embodiment, periodically performs this check for updates and replacements for all clients associated with license database 406. This is noted in FIG. 8 as actions 820 and 822, which denote that software delivery server 402 loops through a set of clients to perform this update/related application check for each client. In a preferred embodiment, software delivery server 402 may loop through the set of clients on a regular basis-once a month, for example.

In a preferred embodiment, the basic process depicted in FIG. 8 may also be used to check for expired or soon-to-expire licenses. Specifically, software delivery server 402 can periodically query license database 406 to determine whether a license has or will soon expire on a client, and similarly prompt a user as to whether the user wishes to renew the license or not. If the user wishes to renew the license, the process depicted in FIG. 6 may be employed to renew the license, with the exception that a license renewal that does not update the installed software application may not require that the application be re-downloaded or re-installed.

It is important to note that while the present invention has been described in the context of a fully functioning data processing system, those of ordinary skill in the art will appreciate that the processes of the present invention are capable of being distributed in the form of a computer readable medium of instructions or other functional descriptive material and in a variety of other forms and that the present invention is equally applicable regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. Functional descriptive material is information that imparts functionality to a machine. Functional descriptive material includes, but is not limited to, computer programs, instructions, rules, facts, definitions of computable functions, objects, and data structures.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
receiving over a network a request to install a software application on a client data processing system, wherein the request includes desired characteristics of the software application;
querying a registry via a service discovery protocol to identify a set of software applications exhibiting the desired characteristics;
obtaining a user selection of a particular software application from the set of software applications;
initiating purchase of a license for the particular software application at a purchase server;
initiating installation of the particular software application at the client data processing system; and
updating a license database to indicate that the software application is licensed for use.

2. The method of claim 1, wherein at least one of the receiving the request, the obtaining the user selection, the querying the registry, the initiating the purchase of the license, the initiating the installation of the particular software application, and the updating the license database includes communicating in a Web services protocol.

3. The method of claim 1, further comprising:
querying the license database to retrieve status information regarding installed software applications on the client data processing system;
determining from the status information whether installation of at least one replacement software application is advisable with respect to at least one of the installed software applications on the client data processing system;
in response to a determination that installation of at least one replacement software application is advisable, providing a notification to the client data processing system to allow a user associated with the client data processing system to decide whether to install any of the at least one replacement software application.

4. The method of claim 3, wherein the status information indicates whether a license to an installed software application has expired or will expire within a pre-determined amount of time.

5. The method of claim 3, wherein the status information indicates that an installed software application has been superceded by a new version.

6. The method of claim 1, wherein the client data processing system is contained within an intranet and at least one of the purchase server, the license database, and the registry is contained within the same intranet.

7. The method of claim 1, wherein at least one of the purchase server, the license database, the license database, and the registry is implemented as a Web service on an internet.

8. The method of claim 1, wherein a license for the software application is purchased by removing a token from a finite set of tokens associated with the software application.

9. The method of claim 8, wherein the finite set of tokens is associated with the software application and an organization that is licensed to use the software application.

10. A computer program product in a computer-readable medium comprising functional descriptive material that, when executed by a computer, enables the computer to perform acts including:
receiving over a network a request to install a software application on a client data processing system, wherein the request includes desired characteristics of the software application;
querying a registry via a service discovery protocol to identify a set of software applications exhibiting the desired characteristics;
obtaining a user selection of a particular software application from the set of software applications;
initiating purchase of a license for the particular software application at a purchase server;
initiating installation of the particular software application at the client data processing system; and
updating a license database to indicate that the software application is licensed for use.

11. The computer program product of claim 10, wherein at least one of the receiving the request, the obtaining the user selection, the querying the registry, the initiating the purchase of the license, the initiating the installation of the particular software application, and the updating the license database includes communicating in a Web services protocol.

12. The computer program product of claim 10, comprising additional functional descriptive material that, when executed by the computer, enables the computer to perform additional acts including:
querying the license database to retrieve status information regarding installed software applications on the client data processing system;
determining from the status information whether installation of at least one replacement software application is advisable with respect to at least one of the installed software applications on the client data processing system;
in response to a determination that installation of at least one replacement software application is advisable, providing a notification to the client data processing system to allow a user associated with the client data processing system to decide whether to install any of the at least one replacement software application.

13. The computer program product of claim 12, wherein the status information indicates whether a license to an installed software application has expired or will expire within a pre-determined amount of time.

14. The computer program product of claim 12, wherein the status information indicates that an installed software application has been superceded by a new version.

15. The computer program product of claim 10, wherein the client data processing system is contained within an intranet and at least one of the purchase server, the license database, and the registry is contained within the same intranet.

16. The computer program product of claim 10, wherein at least one of the purchase server, the license database, the license database, and the registry is implemented as a Web service on an internet.

17. The computer program product of claim 10, wherein a license for the software application is purchased by removing a token from a finite set of tokens associated with the software application.

18. The computer program product of claim 17, wherein the finite set of tokens is associated with the software application and an organization that is licensed to use the software application.

19. A data processing system comprising:
receiving means for receiving over a network a request to install a software application on a client data processing system, wherein the request includes desired characteristics of the software application;
querying means for querying a registry via a service discovery protocol to identify a set of software applications exhibiting the desired characteristics;
obtaining means for obtaining a user selection of a particular software application from the set of software applications;
first initiating means for initiating purchase of a license for the particular software application at a purchase server;
second initiating means for initiating installation of the particular software application at the client data processing system; and
updating means for updating a license database to indicate that the software application is licensed for use.

20. The data processing system of claim 19, further comprising:
means for querying the license database to retrieve status information regarding installed software applications on the client data processing system;
means for determining from the status information whether installation of at least one replacement software application is advisable with respect to at least one of the installed software applications on the client data processing system;
means, responsive to a determination that installation of at least one replacement software application is advisable, for providing a notification to the client data processing system to allow a user associated with the client data processing system to decide whether to install any of the at least one replacement software application.
